(19) United States
(12) Patent Application Publication
(10) Pub. No.: US 2007/0016785 A1
(43) Pub. Date: Jan. 18, 2007

(54) System and method for digital signature and authentication

(76) Inventors: Yannick Guay, Gatineau (CA); Jean-Gregoire Morin, Gatineau (CA)

Correspondence Address: OLSON & HIERL, LTD., 20 NORTH WACKER DRIVE, 36TH FLOOR, CHICAGO, IL, 60606, US

(21) Appl. No.: 11/181,506

(22) Filed: Jul. 14, 2005

(51) Int. Cl. H04L 9/00

(52) U.S. Cl. 713/176

(57) ABSTRACT

A system and method for digital signature captures an electronic rendition of a user's handwritten signature, initials or other writing on a digitizer tablet interfaced with a personal computer, workstation or other computing device. A software plug-in incorporates the signature into the electronic document. The software then hashes the signed document to create a message digest of the signed document which is then encrypted using the user's private key. The recipient of the signed document can authenticate the sender's digital signature by recreating the hash and by decrypting the encrypted hash using the sender's public key. If the locally recreated hash matches the decrypted hash, then the digital signature is authenticated.

### CROSS-REFERENCE TO RELATED APPLICATIONS

This is the first application filed for the present invention.

### FIELD OF THE INVENTION

The present invention relates to digital signatures and, more particularly, to authentication and validation of digital signatures.

### BACKGROUND OF THE INVENTION

With the continued growth and acceptance of the Internet and e-commerce, it is becoming increasingly common for parties and businesses to exchange electronic documents (colloquially known as “soft copies”). These documents, in common formats such as Microsoft Word and Adobe PDF, are commonly sent as e-mail attachments. Such documents often contain sensitive business or financial information such as bank account numbers, bank passwords and transaction details, or may contain confidential personal data such as social insurance numbers, income tax information, etc. To prevent hackers or “data sniffers” from intercepting these documents in cyberspace and then reading them, the sender will typically encrypt those documents usually either a fairly rudimentary password protection or more advanced encryption techniques such as public-key encryption.

While encryption techniques generally solve the problem of data security, a further impediment to the full acceptance of the use of electronic documents and e-commerce is the problem of authenticating the identity of the putative sender. In other words, the recipient may want, or need, to verify that the sender is indeed the person he claims to be and not an impostor. This is critical, for example, in many financial and real estate transactions where the recipient needs to ascertain the identity of the sender.

Cryptography has provided a state-of-the-art solution to this problem in the form of a “digital signature”. A digital signature is essentially an encryption the electronic document which guarantees that the document originated with the sender. The digital signature also ensures data integrity, i.e. that the document was not tampered with since the digital signature was affixed. Moreover, the digital signature protects the recipient against repudiation, i.e. the sender cannot later disclaim the signature by asserting that the signature is not his own.

The concept of the digital signature, which was introduced in 1976 by Diffie and Hellman, is basically an application of public key cryptography. Public key cryptography, which is now well known in art, uses a private key and a public key that are related by a one-way mathematical function. Security is not absolute, but it is postulated that it is computationally infeasible to recreate the private key from knowledge of the encrypted message (the “ciphertext”) and the public key. Public key cryptography is described in many printed publications and patents, but some of the foundational patents include U.S. Pat. No. 4,200,770 (Hellman et al.) entitled “Cryptographic Apparatus and Method” (relating to the Diffie-Hellman key exchange technique) which issued Apr. 29, 1980; U.S. Pat. No. 4,218,582 (Hellman et al.) entitled “Public Key Cryptographic Apparatus and Method” (relating to the Knapsack concept) which issued Aug. 19, 1980; U.S. Pat. No. 4,424,414 (Hellman et al.) entitled “Exponentiation Cryptographic Apparatus and Method” which issued Jan. 3, 1984; and U.S. Pat. No. 4,405,829 (Rivest et al.) entitled “Cryptographic Communications System and Method” (relating to RSA encryption) which issued Sep. 20, 1983.

As noted above, digital signature technology is an application of public key cryptography except applied “in reverse” meaning that rather than encrypting a message with someone's public key for the recipient to decrypt using their corresponding private key, a digital signature requires the sender to “sign”, or “encrypt”, with the sender's private for authentication by the recipient having access to the sender's corresponding public key.

To digitally sign a document, the document is first “hashed” using a so-called “hashing function”, also known as a message digest algorithm. This algorithm generates a hash of the document. The hashing function can be a checksum or other mathematical function. The hashing function essentially creates a hash or digest of the document that, while not perfectly unique, is rare enough that it is highly unlikely that two different documents yield the same hash. The purpose of hashing a document is to shorten it, to thus alleviate the computational requirements of encrypting the message. In other words, it is computationally too slow to encrypt the entire document so it is preferable to first create a shortened version or digest of the document which can be encrypted more quickly. However, in theory, hashing is not essential to the formation of a digital signature, although as a practical matter hashing makes digital signatures computationally much more feasible.

Once the hash or message digest is created, the next step in the digital signature procedure is to encrypt the message digest or hash with the sender's private key. The result of encrypting the hash is a digital signature. This digital signature is appended to the electronic document to form a digitally signed document which can then be sent to the recipient for authentication.

When the recipient receives the electronic document with the appended encrypted hash, the recipient recreates the hash of the document by using the same, pre-agreed message hash algorithm that the sender used. The recipient then encrypts the new (locally recreated) hash. The recipient then uses the sender's public key (corresponding mathematically to the sender's private key) to decrypt the digital signature to recover the sender's hash. The recipient can then compare the locally recreated hash with the sender's hash (now decrypted). If the hashes match, the digital signature is authentic. In other words, the recipient can be confident that the document received really originated from the sender and, furthermore, that no one altered it during transmission. If the hashes do not match, the authentication fails and the recipient knows that either the sender is an impostor, or that the document has been tampered with, or that a transmission error has changed the document contents.

Commonly utilized hashing algorithms are Message Digest 5 (MD5) and Secure Hash Algorithm 1 (SHA-1) . MD5 produces a 128-bit hash while SHA-1 produces a 160-bit hash. The hash algorithm is a one-way function which is computational infeasible to reverse. In other words, it is practically impossible to recreate the original document contents from a message hash. Furthermore, the probability that two different documents yield the same hash is negligible. For example, the probability that MD5 will output the same hash for two different documents (a “collision”) is 1/2128.

In some respects, a digital signature can be far superior to a traditional handwritten signature. An expert forger can forge a person's signature, alter the contents of a signed document, or move a signature from one document to another without being detected. Digital signature technology, however, alerts the recipient of any change in a signed document or the replacement of a signature. However, the one main weakness of digital signature technology is that the private key used by the sender to digitally “sign” his documents must be kept absolutely secret. If the private key falls into the wrong hands, the impostor can digitally sign any document with impunity. Therefore, the security of a digital signature is only as good as the security used to lock up the private key. Typically, the sender can encrypt his private key and store the encrypted private key on a hard drive of his personal computer, or alternatively on a password-protected CD-ROM or floppy disk or on a solid-state memory device like a flash memory stick or smartcard. In contrast, the corresponding public key is made publicly accessible or otherwise delivered to intended recipients so that the recipients of documents can use the sender's public key to verify or authenticate the sender's digital signature. The public key can be published in a company directory, or sent directly to desired recipients for storage of the public key in their own computers.

Another issue that arises with digital signature technology is that recipients need to verify that the sender's public key is, in fact, genuine. Without a form of assurance that a public key is indeed genuine, the recipient cannot be sure that a signed document and its accompanying public key are actually from the purported sender. By using a recipient's name and by generating a bogus public-private key pair, an impostor, identity thief, or con artist could create a document and use the false private key to sign it, then send the signed document and false public key to the recipient. Unless the recipient has a means of verifying that the public key actually belongs to the purported sender, the digital signature is essentially worthless as a means of authentication. Therefore, sender and receiver must establish a public key trust relationship before exchanging documents.

There are two public key trust paradigms: the direct trust paradigm and third-party trust paradigm. In the direct trust paradigm, sender and receiver know and trust each other directly and exchange public keys personally or securely. In the third-party trust paradigm, sender and receiver rely on a trusted third party since sender and receiver either might not know or trust each other or might not have a secure means of exchanging keys and authenticating each other. The third-party trust paradigm is therefore well suited to large communities of users or the Internet in general.

The third-party trust paradigm typically requires a Certificate Authority, i.e. a trustworthy organization that certifies public keys, such as VeriSign. These Certificate Authorities certify public keys by issuing users a digital certificate that contains the user's identity, public key, and key expiration date. The recipient of a digital signature can trust a sender's public key if he trusts the sender's Certificate Authority and has duly ascertained that the sender's certificate is valid.

Despite growing acceptance of digital signatures in e-commerce, the vast majority of transactions, be it financial, legal or otherwise, still require an actual handwritten signature on the document. Conventionally, the signatory (sender) has to print out a hard-copy of the electronic document in order to sign the document. Once signed, the document is either faxed or scanned for emailing as an attachment. In either case, both time and paper are wasted in the conversion of electronic to paper form. Furthermore, the signed paper copy must either be stored or destroyed, but of which represent unnecessary expenses to business and customer alike.

One solution to the problem of affixing handwritten signatures (or initials or other handwriting) to electronic documents is to use digitizer tablets or other signature-capturing input devices. Digitizer tablets, also known as graphics tablets, are generally peripheral devices connected to a personal computer for capturing handwriting via a pen-like handheld device known as a stylus. The stylus can be wireless or connected to the tablet via a cord or wireline. The digitizer tablet can have a pressure-sensitive screen or panel that typically creates a bitmap (or alternatively vector graphics) of the trace of the stylus over the pressure-sensitive screen due to localized changes in electrical properties of the screen due to the pressure of the stylus which “draws” pixel by pixel an image of the person's signature or other handwriting. Alternatively, the digitizer tablet can use an optical sensor and a grid panel to recreate the movements of the stylus as it traverses the grid panel.

Some examples of digitizer tablets are found in U.S. Pat. No. 4,213,005 (Cameron) entitled “Digitizer Tablet” which issued Jul. 15, 1980; U.S. Pat. No. 4,455,451 (Kriz) entitled “Digitizer Tablet” which issued Jun. 19, 1984; U.S. Pat. No. 4,943,689 (Siefer et al.) entitled “Backlit Digitizer Tablet” which issued Jul. 24, 1990; U.S. Pat. No. 5,004,872 (Lasley) which issued Apr. 2, 1991; U.S. Pat. No. 5,466,895 (Logan) entitled “Wear Resistant Improved Tablet for a Digitizer” which isused Nov. 14, 1995; U.S. Pat. No. 5,416,280 (McDermott et al.) entitled “Digitizer Tablet Using Relative Phase Detection” which issued May 16, 1995; U.S. Pat. No. 5,357,061 (Crutchfield) entitled “Digitizer Tablet Having High Permeability Grid Shield” which issued Oct. 18, 1994; and U.S. Pat. No. 5,072,076 (Camp, Jr.) entitled “Tablet Digitizer with Untethered Stylus” which isused Dec. 10, 1991.

Despite all of the foregoing innovations, the current practice of signing electronic forms and other electronic documents and then securely transmitting them to a recipient and enabling the recipient to authenticate the signature continues to pose a significant impediment to electronic commerce and other Internet-based transactions. Accordingly, it would be highly desirable to provide an improved system and method for signing electronic documents that would enable a person to sign a document with a high-fidelity electronic rendition of his signature and then to transmit the signed document securely to the intended recipient without having to print out a paper copy of the document and whereby the recipient would be able to authenticate the signature of the sender.

### SUMMARY OF THE INVENTION

An object of the invention is therefore to provide an improved method and system for digital signature and authentication which entails paperless capture of an electronic rendition of a sender's signature, hashing and encryption of the signed electronic document, and transmission to a recipient whereby the latter would be able to view and authenticate the signature appearing on the electronic document.

Accordingly, in general, the invention provides a system, method and computer-readable medium that incorporates into an electronic document (such as a form to be signed) a digitized version or electronic rendition, of a handwritten signature captured by a digitizer tablet or other signature-capturing input device. Subsequent to capture and incorporation of the digitized rendition of the handwritten signature, the signed document is hashed by a one-way hashing function to create a message digest or “hash”. The hash is then encrypted using a private key stored in a privately held keystore and thus available only to the signatory, e.g. a password-protected private key. The encrypted hash thus constitutes a digital signature that is unique to the signatory, provided that only the signatory has access to the unique private key. The signed electronic document can then be transmitted to a recipient who locally recreates a hash of the received document and then decrypts the hash created with the private key for comparison with the locally recreated hash. Where there is concordance, or a “match”, a signature authentication icon can be displayed on a graphical user interface visible to the recipient indicating that the signature of the signatory is valid and authentic. Where there is a lack of concordance, the graphical user interface displays an icon indicating that authentication has failed.

The present invention therefore provides a system for capturing and incorporating an electronic rendition of a signatory's handwritten signature into an electronic document and digitally signing the electronic document. The system includes a digitizing signature-capture device for capturing a handwritten signature of the signatory; means for incorporating the electronic rendition of the signatory's signature into the electronic document to create a graphically signed electronic document; means for hashing the signed electronic document to create a hash; and means for encrypting the hash with a private key to create a privately encrypted hash thus enabling a recipient of the electronic document and the privately encrypted hash to authenticate the digital signature by decrypting the privately encrypted hash with a public key corresponding to the private key to thus recover the hash created by the signatory and by comparing the hash decrypted using the public key with a locally recreated hash of the document.

The present invention further provides a method for capturing and incorporating an electronic rendition of a signatory's handwritten signature into an electronic document and digitally signing the electronic document. The method includes the steps of: capturing the electronic rendition of the signatory's handwritten signature; incorporating the electronic rendition of the signature into the electronic document; hashing the electronic document to create a hash; and encrypting the hash with a private key thus enabling a recipient of the electronic document and the encrypted hash to authenticate the digital signature using a public key corresponding to the private key.

The present invention further provides a computer-readable medium storing computer-executable coded instructions for incorporating into an electronic document data received from a signature-capturing input device; for creating a hash of the document; and for encrypting the hash using a private key to thus constitute a unique digital signature thus enabling a recipient of the document to authenticate the digital signature by decrypting the hash received with the document with a public key corresponding to the private key and for comparing the decrypted hash with a locally recreated hash of the document.

Other advantages and features of the invention will be better understood with reference to preferred embodiments of the invention described hereinafter.

### BRIEF DESCRIPTION OF THE DRAWINGS

Having thus generally described the nature of the invention, reference will now be made to the accompanying drawings, showing by way of illustration the preferred embodiments thereof, in which:

FIG. 1 is a flowchart depicting the installation of system software on a local workstation, the creation of a private-public key pair, and the storage of the private key in a privately held keystore and of the public key in a publicly accessible certificate repository hosted on a web-based server, in accordance with an embodiment of the present invention;

FIG. 2 is a flowchart depicting a method of signature capture and digital signature in accordance with an embodiment of the present invention; and

FIG. 3 is a flowchart depicting a method of authenticating the digital signature in accordance with an embodiment of the present invention.

### DETAILED DESCRIPTION OF THE PREFERRED EMBODIMENTS

In general, and as will be elaborated below, a system and method for digital signature captures an electronic rendition of a user's handwritten signature, initials or other writing on a digitizer tablet interfaced with a personal computer, workstation or other computing device. A software plug-in incorporates the signature into the electronic document. The software then hashes the signed document to create a message digest of the signed document which is then encrypted using the user's private key. The recipient of the signed document can authenticate the sender's signature by locally recreating a hash of the received document and by decrypting the received encrypted hash of the document using the sender's public key. If the locally recreated hash matches the decrypted hash, then the digital signature is authenticated. The private key is kept secret by securely storing it within a protected keystore while the public key is communicated to the intended recipient or stored in a publicly accessible certificate repository such as a web-based server.

An embodiment of the present invention therefore provides a system for capturing and incorporating an electronic rendition of a signatory's handwritten signature into an electronic document and then digitally signing the electronic document for authentication by a recipient. The system includes a computer or computing device (which could be a workstation on a LAN or WAN or a PDA such as a Palm Pilot™ or Blackberry™) which includes either as an integral component thereof or as a peripheral device a signature-capturing device capable of digitizing a person's signature or other handwriting. The PDA can also function as a signature-capture device to capture an electronic rendition of a signature to provide it to another computing device by wireline, wireless or infrared. In a preferred embodiment, the signature-capturing device is a digitizer tablet connected as a peripheral device to a computer for capturing a handwritten signature of the signatory. In the preferred embodiment, the computer has a graphical user interface (GUI), such as a CRT-type monitor or LCD screen for displaying an electronic document to a signatory (also known herein as the “user” or “sender”). The electronic document may be an application form, authorization form, contract, or other document requiring a signature, initials or other handwriting to give it proper legal and commercial effect. Therefore, when the electronic document is presented to the user, the user can read the document on the computer screen, scrolling down when necessary, and then the user, if he so desires, can sign his name onto the digitizer tablet. The system includes means for incorporating the electronic rendition of the user's signature into the electronic document to create a graphically signed electronic document. In the preferred embodiment, the means for importing and incorporating the captured digitized handwriting is computer-readable coded instructions in the form of software or a “plug-in” adapted to operate with known document-creating or form-generating software such as Adobe PDF, Microsoft Word or effectively any other format or type of software. The system plug-in imports or incorporates the electronic rendition or digitized version of the handwritten signature (or other handwriting) into the form or document, displaying it in the correct signature field for the user (now the “signatory”) to view.

The digitizer tablet, also known as a graphics tablet, can be connected to a typical personal computer via a serial port connector, e.g. a 9-pin D-shell connector or via a USB (Universal Serial Bus). The digitizer tablet either has a corded or cordless pen or stylus for inscribing a signature on a pressure-sensitive array that creates a bitmap of the signature. Alternatively, as is known in the art, the digitizer tablet can use vector graphics instead of a bitmap. The tablet can also produce a vector graphics format which can then be converted into a bitmap for display on a monitor or for printing. As is known by programmers of graphics software, vector graphics can be converted into bitmaps by a technique known as rasterizing.

The signature-capture device could also be a digitizing pen having an optical sensor such as, for example, the Logitech® io™ Digital Writing System. This pen enables a user to capture and digitize handwriting using a tiny camera embedded in the pen when the pen is moved over the surface of “smart digital paper”. The smart digital paper includes a pattern of printed dots that enable localization of the captured written words and symbols.

In the preferred embodiment, the digitizer tablet or other signature-capture device such as the digitizing pen directly transfers the bitmap or vector graphic of the signature to volatile memory (e.g. DRAM or SRAM) without saving the bitmap or vector graphic as a graphics file in any non-volatile memory. The direct transfer of the signature capture to the document without intermediate storage of the signature capture enhances overall system security by precluding the possibility that an impostor could gain access to the signature file and then use it to impersonate the sender. Of course, the impostor would also have to gain access to the sender's private key to fully impersonate the sender because without access to the private key, the digital signature would not be authentic.

Once the document has been graphically signed by incorporation of the electronic rendition of the handwritten signature into the document, the system creates a digital signature for authentication, data integrity and non-repudiation purposes. The digital signature is created by hashing the electronic document and by subsequently encrypting the hash, as will be elaborated below. The system therefore includes means for hashing the signed electronic document to create a hash or message digest.

In the preferred embodiment, the hashing means is an MD5 hashing function. According to the executive summary of RFC 1321, the MD5 Message-Digest algorithm (which was developed by Professor Ronald L. Rivest of the Massachusetts Institute of Technology) “takes as input a message of arbitrary length and produces as output a 128-bit “fingerprint” or “message digest” of the input. It is conjectured that it is computationally infeasible to produce two messages having the same message digest, or to produce any message having a given predetermined target message digest. The MD5 algorithm is intended for digital signature applications, where a large file must be “compressed” in a secure manner before being encrypted with a private (secret) key under a public-key cryptosystem such as RSA.” As is known in the art, “hashing function” can also be known as a cryptographic checksum or cryptographic hashcode. It should be expressly understood that other hashing functions can be used instead of MD5, such as MD2 and MD4 which are message-digest algorithms developed by Rivest. Each of these message digests algorithms are meant for digital signature applications where a large message has to be “compressed” in a secure manner before being signed with the private key. All three of these algorithms take a message of arbitrary length and produce a 128-bit message digest. Other known hashing functions could be used instead, such as RIPEMD, HAVAL, SNEFRU, or Secure Hash Algorithms such as SHA-1 or SHA-256.

The system also includes means for encrypting the hash with a private key to create a privately encrypted hash thus enabling a recipient of the electronic document and the privately encrypted hash to authenticate the digital signature by decrypting the privately encrypted hash with a public key corresponding to the private key to thus recover the hash created by the signatory and by comparing the hash decrypted using the public key with a locally recreated hash of the document. In the preferred embodiment, the means for encrypting the hash with the private key is RSA public key encryption which is known to work well with MD5 hashing. Alternatively, the means for encrypting could be ElGamal public-key encryption. In the preferred embodiment, the public key mathematically corresponds to the private key, as is well known in the art. For RSA encryption, the private and public keys are two extremely large prime numbers. The security of RSA is based on the computational infeasible of factoring the product of the two prime numbers. The public key is used to decrypt the privately encrypted hash, i.e. the originally created hash that was transmitted to the recipient along with the document. The recipient decrypts the privately encrypted hash, i.e. the received hash, using the public key corresponding to the private key, and thus recover the original hash, i.e. the hash that was created by the sender. The recipient also locally recreates a hash of the document using the same hashing function (this would be pre-agreed or otherwise signaled to the recipient). The recipient then compares the locally recreated hash with the decrypted hash. If the locally recreated hash and the decrypted hash are identical, then the recipient knows that the digital signature is authentic. If the locally recreated hash and the decrypted hash do not match, then the recipient knows that the digital signature is invalid. In the preferred embodiment, the authentication is performed by software residing on the recipient's computer or other computer-like device. The system graphically presents signed document on the recipient's computer screen and authenticates the digital signature by decrypting the encrypted hash, locally recreating a hash of the document, and comparing the decrypted hash with the locally recreated hash. If the decrypted hash matches the locally recreated hash, the system displays a signature authentication icon on the screen to visually indicate to the recipient that the digital signature has been authenticated. If the two hashes do not match, an authentication failure icon is displayed. In lieu of an authentication icon (or failure icon), the system can display a message in a pop-up window, play a sound, or speak a digitally prerecorded statement to inform the recipient of the authenticity of the digital signature.

In order to protect a digital signature, the private key must be kept secret and held in a private keystore. To ensure security, only the sender should have access to the private key. In the preferred embodiment, the private key itself is encrypted. One approach is to password-protect the private key in a private keystore on the sender's hard drive or on a floppy disk, CD-ROM, memory stick or other storage medium that can be encrypted by a password and then stored in a safe for double protection.

The public key, on the other hand, can be stored in a publicly accessible certificate repository, directory or database or distributed to selected recipients. A certificate repository, as is known in the art, is able to contain a large number of different digital certificates for various users, thus enabling recipients to verify a user's identity, i.e. that the public key actually corresponds to the sender. As is known in the art, digital certificates are created, or “certified”, by a trusted third party known as a Certification Authority. Before a sender can digitally sign a document, he must first have his certificate enrolled. Certificate enrollment requires that the sender provide the Certificate Authority with a copy of his public key along with personal information identifying the sender, such as the sender's name, address, social security number (or social insurance number), etc. In one embodiment, the sender can only enroll if he inputs a unique product identifier such as a product serial number contained on the CD-ROM or inside the software box. The Certificate Authority would ensure that the serial number is enrolled only once. In another embodiment, the serial number could be correlated to a specific individual at the point of purchase, e.g. the identity of the purchaser/sender can be correlated via credit card information, photo ID, etc. to a specific product serial number as a further check that the purchaser of the software (the sender) is indeed who he purports to be when he enrolls with the Certificate Authority.

After the Certificate Authority receives the public key and personal information identifying the sender, the Certificate Authority creates a certificate and encrypts it with one of its own private keys. The certificate is then returned to the sender, with an indication that the certificate has been enrolled. The certificate can also include a key expiration date after which the user needs to re-enroll. Also, provision can be made for users to automatically renew the certificate when expired.

In the preferred embodiment, the sender's public key is stored in a publicly accessible certificate repository hosted on a web-based server. Alternatively, the public key can be distributed to one or more intended recipients or made available to a restricted community of recipients.

Accordingly, the system captures and incorporates an electronic rendition of the signatory's signature, hashes and encrypts the graphically signed document with a private key unique to the sender and then transmits the graphically signed document to the recipient along with an appended encrypted hash constituting the digital signature. The recipient's system recreates the hash locally and decrypts the encrypted hash. Provided that the two hashes match, the system declares that the digital signature is authentic. In addition to authentication of the sender's identity, the digital signature also provides a data integrity check (indicating whether the document was changed or tampered with) and also provides a non-repudiation function, meaning that the sender cannot later claim that he did not sign the original message except if he can prove that an impostor came into possession of his privately held key.

Another embodiment of the present invention therefore provides a method for capturing and incorporating an electronic rendition of a signatory's handwritten signature into an electronic document and digitally signing the electronic document. The method includes an initial step of capturing the electronic rendition of the signatory's handwritten signature. In the preferred embodiment, the signature capture is performed using a digitizer tablet, although other equivalent devices can be also be used. The next step entails incorporating the electronic rendition of the signature into the electronic document. Preferably, this is done using software or a plug-in for graphically importing the rendition of the signature into the form or document and placing it in the correct signature field. The computer or computer-like device then displays the electronic rendition of the handwritten signature in the signature field for the user to view. Subsequently, the electronic document is hashed using a hashing function, preferably but not necessarily MD5. Subsequently, the hash is encrypted with a private key thus enabling a recipient of the electronic document and the encrypted hash to authenticate the digital signature using a public key corresponding to the private key. Authentication is performed by decrypting the encrypted hash using the sender's public key corresponding to the sender's private key and by comparing the decrypted hash with a hash regenerated at the recipient's end by re-applying the same hashing function to the received electronic document. If the two hashes match, then the digital signature is authentic. If the two hashes do not match, then the digital signature is not authentic.

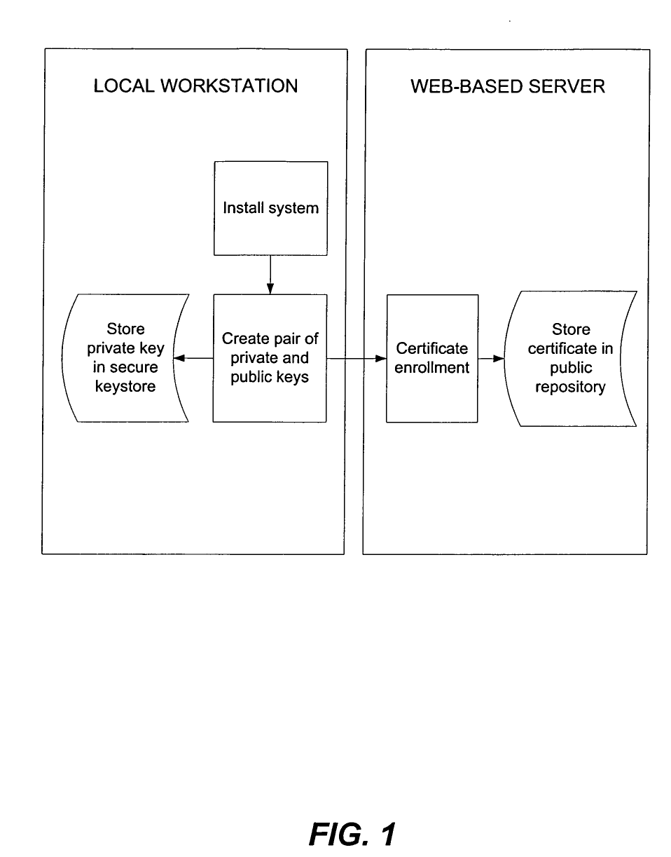

Prior to capturing and importing the handwritten signature, the system must be installed or set up. System installation first requires installation of a digitizer tablet, if one is not already connected to the computer or integral with the computing device (e.g. a PDA may have an integral digitizer screen). After installation of the peripheral device and of any required software drivers, the system installation follows the set-up procedure depicted in FIG. 1. The first step is to install the system software, or plug-in on the local workstation (i.e. on the computer or computing device). This is done by inserting a CD-ROM or floppy disk or other memory device into the computer to load the software or plug-in into the memory of the computer or computing device. The software would launch an “installation wizard” to guide the user through the set-up, perhaps offering either standard set-up or a customization of the system configuration.

As shown in FIG. 1, the next step of the method entails creating a private key and a corresponding public key, also known as a private-public key pair. In the preferred embodiment, the private-public key pair are represented by large prime numbers as needed to operate the RSA (Rivest-Shamir-Adleman) algorithm.

In the preferred embodiment, the private key is then stored in a privately held (secure) keystore whereas the public key is stored in a publicly accessible certificate repository, preferably hosted on a web-based server. The software can then create a password-protected private keystore (i.e. a restricted-access file) directly on the user's hard drive or in on any other type of computer-readable storage medium such as a floppy disk, CD-ROM, or memory stick. As also shown in FIG. 1, in the preferred embodiment, the public key is certified by a trusted third-party (preferably a Certificate Authority) prior to storage in the public repository. The Certificate Authority issues a certificate attesting that the public key actually and rightfully belongs to the user.

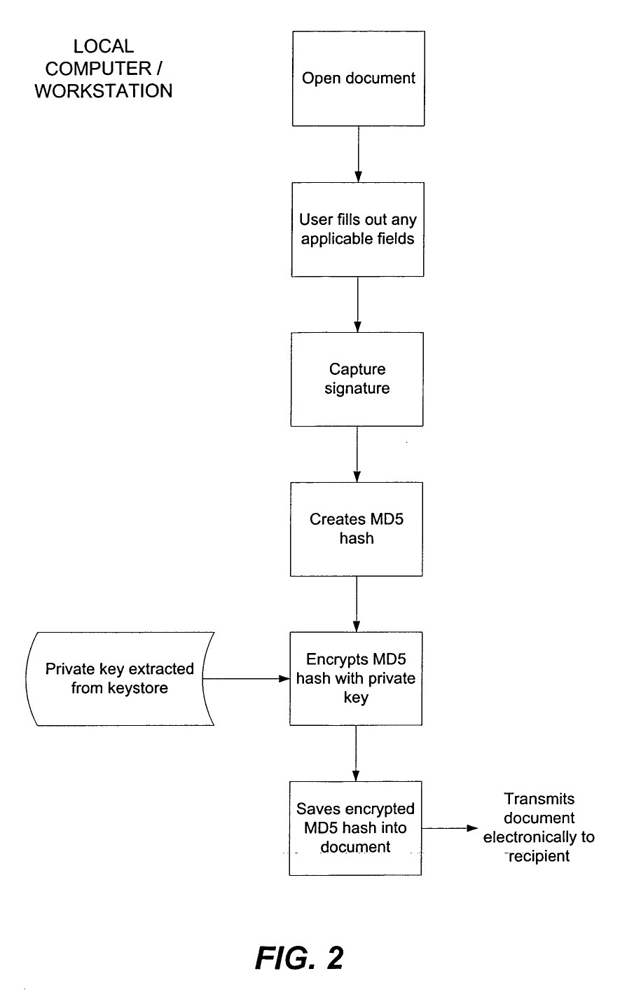

FIG. 2 depicts the method of capturing and incorporating an electronic rendition of a handwritten signature into an electronic document (“graphically signing”) and then hashing and encrypting (“digitally signing”) the document for authentication by the recipient. As shown in FIG. 2, the first step is to open the document (e.g. the form to be signed). The user then fills out any applicable fields by typing in the required information. When the form is filled out, the user then signs with a stylus on a digitizer tablet or other such signature-capturing device (be it a peripheral device or integrally connected with the computing device). The signature is captured (e.g. as a bitmap or vector graphics) and imported for incorporation into the document. A time-stamp may also be generated and incorporated into the document. Graphically, the electronic rendition of the user's signature will now appear on a graphical user interface (e.g. a LCD or CRT monitor or screen) for viewing by the user. Once the document is graphically signed, the document is passed through a hashing function to create a hash. The hashing is preferably done with an MD5 message digest algorithm (although others could be used, such as MD2 or MD4 or any of the SHA family of algorithms, for example). The user enters his password to extract his private key from the secure keystore. This private key is then used to encrypt the hash. The privately encrypted hash thus constitutes a digital signature. In other words, by encrypting the hash, the signatory (user) digitally signs the electronic document. The digital signature (the encrypted MD5 hash) is saved into the electronic document or appended to it and then the document with digital signature is transmitted to one or more recipients.

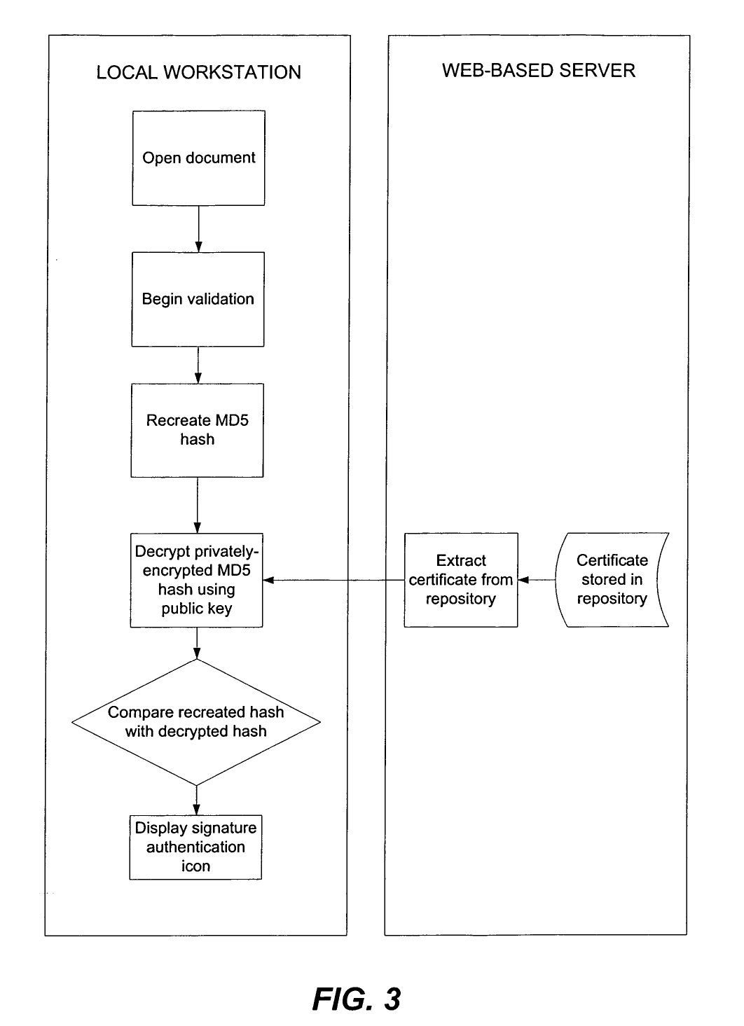

As depicted in FIG. 3, when the recipient receives the digitally signed document, the first step is to open the document and to view the document and graphical rendition of the signature on the recipient's local workstation. If the recipient knows the sender, then validation of the graphical signature can be first undertaken by visual inspection or visual comparison with a previously signed document or with a signature sample believed to be authentic. The recipient will also generally read the document on the screen to make sure it contains all of the necessary information (i.e. that all of the fields have been properly filled in). Next, the recipient (or rather the recipient's system) validates the digital signature. This is done by locally recreating the hash of the document on the recipient's local workstation (i.e. his computer or computing device). The recipient extracts the sender's pubic key from the certificate repository and then decrypts the privately-encrypted hash with the corresponding public key. The next step is to compare the locally recreated hash with the decrypted hash. If the two hashes match, then a signature authentication icon is displayed (or other visual or auditory notification is provided).

In another embodiment, the foregoing method is stored on a computer-readable medium in the form of computer-executable coded instructions for incorporating into an electronic document data received from a signature-capturing input device; for creating a hash of the document; and for encrypting the hash using a private key to thus constitute a unique digital signature thus enabling a recipient of the document to authenticate the digital signature by decrypting the hash received with the document with a public key corresponding to the private key and for comparing the decrypted hash with a locally recreated hash of the document.

It will also be appreciated by those skilled in the art that a computer-readable medium has computer-executable code, or instructions, for directing a data processing system to implement the graphical and digital signature method described above. The computer-readable medium can be embodied as a computer program product or as a computer-readable memory, in which the memory can be a CD, floppy disk or hard drive or any sort of memory device usable by a data processing system such as a memory stick or flash memory smartcard. It will also be appreciated, by those skilled in the art, that a data processing system may be configured to operate the method (either by use of computer executable code residing in a medium or by use of dedicated hardware modules, also generally or generically known as mechanisms or means, which may operate in an equivalent manner to the code.

For the purposes of the present specification, the expression “handwritten signature” shall include initials or other handwriting that a person may need to inscribe on a form, contract, authorization or any other document and shall also include signatures inscribed by handicapped individuals who use mouth-writing or foot-writing as a substitute for handwriting.

Although the foregoing description makes reference to a signature, it should be expressly understood that the handwriting could be other words, symbols or initials. Furthermore, it should be expressly understood that the system and method could be adapted to handle multiple signatures from multiple signatories or any combination of signatures, initials, words, symbols, etc. from one or more individuals. For example, the same document can be signed and countersigned by two or more individuals, each applying their own private key to digitally sign the document. The document would then be transmitted to a third party with two encrypted hashes. The third party recipient would then use different public keys corresponding to each of the signatories to decrypt each encrypted hash in order to authenticate each signatory's digital signature.

In another scenario, as is often the case for mortgage, car or business loan applications, investment instructions and the like, a banker, loan officer, or financial adviser will meet with a client (whose identity is either already known or whose identity can be properly established) and then both the client and banker (or officer or adviser) will then graphically sign the document or application. In this scenario, since the banker/adviser/officer vouches for the identity of the client, only the banker/adviser/officer needs to digitally sign the document with his private key. The recipient can legitimately trust the authenticity of both signatures if the recipient validates the banker's digital signature and if the recipient trusts the banker to have properly identified his client prior to accepting his signature on the document.

The foregoing system and method can be implemented to support a variety of standards such as the well-established Public-Key Cryptography Standards (PKCS). As is known in the art, the Public-Key Cryptography Standards are cryptographic specifications that were written by RSA Laboratories in cooperation with secure systems developers from around the world to promote standardization, acceptance and deployment of public-key cryptography. For example, the system and the method of the present invention can be adapted to support PKCS#7 for signature. Certificates can be generated and enrolled according to X.509 v1 or v3. Verification of a certificate can follow the X.509 CRL standard, for example by retrieving the Certificate Revocation List using a CDP extension or using locally configured Hypertext Transfer Protocol (HTTP) or a Lightweight Directory Access Protocol (LDAP) address. Alternatively, instead of periodically accessing a Certificate Revocation List, the system and method of the present invention can be made to support Online Certificate Status Protocol (OCSP) such as RFC2560. As is known in the art, OCSP was designed to overcome the main limitation of CRL, i.e. that updates need to be periodically downloaded to keep the CRL up to date at the recipient's end. When a recipient accesses a certificate repository, the Online Certificate Status Protocol sends a request for certificate status information. The repository returns a response of “current”, “expired,” or “unknown.” Finally, as is known in the art, the system and method can be adapted to support secure smart cards or USB tokens. These smart cards or USB tokens can be used to store personalized digital credentials, for example according to PKCS#11. These smart cards or USB tokens enable a user to physically transport a private key for signing documents at remote locations. The foregoing standards are mentioned merely by way of example and should not be considered as limiting the invention in any way. As will be readily appreciated by those of ordinary skill in the art, the system and method of the present invention can be adapted to support other standards as well.

In another embodiment, the system and method of the present invention can further include means for, or the step of, obtaining an electronic rendition of a fingerprint or other biometric to further authenticate the identity of the signatory. The means for providing the electronic rendition of the fingerprint can be a fingerprint scanner and associated software or plug-in, which provides a biometric authentication of an enrolled signatory. Fingerprint scanners are now known in the art. Fingerprinting scanning technology is disclosed in, for example, U.S. Pat. Nos. 6,886,104; 6,828,960; 6,744,910, 6,658,164; 6,628,813; 6,263,090; 6,178,255; 6,122,394 as well as U.S. Patent Application Publications 20050111707; 20050111706; 20040156555; 20030128240; 20030062202; 20020021827; and 20010033677, all of which are hereby incorporated by reference. In this embodiment, the fingerprint scan (the digital rendition of the scan itself or a hash thereof) could be used as a seed to generate a private key that is absolutely unique to each individual. Therefore, using a fingerprint scanner, a user of the system would no longer need to securely store a private key, but rather would simply put his finger on a fingerprint scanner to generate the private key. The corresponding public key would of course be derived mathematically from the private key, as is known in the art.

The embodiments of the invention described above should be understood to be exemplary only. Modifications and improvements to those embodiments of the invention may become apparent to those skilled in the art. The foregoing description is intended to be exemplary rather than limiting. The scope of the invention is therefore intended to be limited solely by the scope of the appended claims.

What is claimed is:

1. A system for capturing and incorporating an electronic rendition of a signatory's handwritten signature into an electronic document and digitally signing the electronic document, the system comprising:
a digitizing signature-capture device for capturing a handwritten signature of the signatory;
means for incorporating the electronic rendition of the signatory's signature into the electronic document to create a graphically signed electronic document;
means for hashing the signed electronic document to create a hash; and
means for encrypting the hash with a private key to create a privately encrypted hash thus enabling a recipient of the electronic document and the privately encrypted hash to authenticate the digital signature by decrypting the privately encrypted hash with a public key corresponding to the private key to thus recover the hash created by the signatory and by comparing the hash decrypted using the public key with a locally recreated hash of the document.

2. The system as claimed in claim 1 wherein the digitizing signature-capture device is a digitizer tablet peripherally connected to a computing device.

3. The system as claimed in claim 1 wherein the means for incorporating the electronic rendition of the user's signature into the electronic document to create a graphically signed electronic document comprises computer-readable coded instructions for incorporating the electronic rendition of the signature into the electronic document and to display the electronic rendition of the signature and the electronic document on a graphical user interface visible to the user.

4. The system as claimed in claim 1 wherein the hashing means comprises an MD5 hashing function.

5. The system as claimed in claim 1 wherein the encrypting means comprises RSA-based public key encryption.

6. A method for capturing and incorporating an electronic rendition of a signatory's handwritten signature into an electronic document and digitally signing the electronic document, the method comprising the steps of:
capturing the electronic rendition of the signatory's handwritten signature;
incorporating the electronic rendition of the signature into the electronic document;
hashing the electronic document to create a hash; and
encrypting the hash with a private key thus enabling a recipient of the electronic document and the encrypted hash to authenticate the digital signature using a public key corresponding to the private key.

7. The method as claimed in claim 6 further comprising the steps of, prior to the capturing step:
creating a private key and a corresponding public key;
storing the private key in a privately held keystore;
and
storing the public key in a publicly accessible repository.

8. The method as claimed in claim 7 wherein the step of capturing the electronic rendition of the handwritten signature is performed using a digitizer tablet peripherally connected to a computing device.

9. The method as claimed in claim 7 wherein the hashing step is performed using an MD5 hash.

10. The method as claimed in claim 7 wherein the encrypting step is performed using RSA-based public key encryption.

11. The method as claimed in claim 10 wherein the private key is locally stored in a password-protected private keystore.

12. The method as claimed in claim 10 wherein the public key is stored on a publicly accessible web-based server.

13. The method as claimed in claim 6 further comprising the steps of:
transmitting to the recipient the electronic document and the hash encrypted with the private key of the signatory;
authenticating, by the recipient, the signature of the signatory by:
creating a local hash of the electronic document;
decrypting the hash received with the document by using a public key corresponding to the private key; and
comparing the local hash with the hash decrypted with the public key.

14. The method as claimed in claim 13 wherein the step of decrypting the received hash with the public key comprises the step of first extracting the public key from a certificate repository hosted by a web-based server.

15. The method as claimed in claim 13 further comprising the step of displaying an authentication icon on a graphical user interface indicating to the recipient that the signature of the signatory is authentic.

16. A computer-readable medium storing computer- executable coded instructions comprising:
instructions for incorporating into an electronic document data received from a signature-capturing input device;
instructions for creating a hash of the document; and
instructions for encrypting the hash using a private key to thus constitute a unique digital signature thus enabling a recipient of the document to authenticate the digital signature by decrypting the hash received with the document with a public key corresponding to the private key and for comparing the decrypted hash with a locally recreated hash of the document.

17. The computer-readable medium as claimed in claim 16 wherein the signature-capturing input device is a digitizer tablet capable of generating a digital rendition of a signature.

18. The computer-readable medium as claimed in claim 16 further comprising instructions for displaying an authentication icon on a graphical user interface visible to the recipient.

19. The computer-readable medium as claimed in claim 16 further comprising:
instructions for creating a private key and a corresponding public key;
instructions for storing the private key in a privately held keystore; and
instructions for storing the public key in a publicly accessible repository.

20. The computer-readable medium as claimed in claim 19 wherein the private key is generated using a fingerprint scan.
